(19) United States
(12) Patent Application Publication
(10) Pub. No.: US 2007/0093213 A1
(43) Pub. Date: Apr. 26, 2007

(54) Method and system for electromagnetic field evaluation

(76) Inventors: Davide Filizola, TORINO (IT); Alessio Roselli, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/584,803

(22) PCT Filed: Dec. 30, 2003
(86) PCT No.: PCT/IB03/06228

§ 371 Date: Jun. 28, 2006

(51) Int. Cl. H04B 17/00

(52) U.S. Cl. 455/67.16; 340/825.49; 340/539.13; 342/457; 455/456.2

(57) ABSTRACT

The field received starting at least one source of electromagnetic field in a determined position of the territory covered by a communication network has a plurality of field sources estimated on the basis of a propagation model. The model in question is modified, for example, in parametric fashion according to the topology of said field sources. Preferential application to locating mobile terminals, in particular in view of the provision of services based on location.

### TECHNICAL FIELD

The invention relates to the techniques that allow to estimate, according to propagation models, the level of electromagnetic field present in a determined geographic position and produced by a given source or by a given set of sources.

Theses techniques play an important role in planning, designing, constructing and operating communication networks, especially in view of performance optimisation in networks such as cellular mobile radio telecommunication networks. In particular, the ability to evaluate the level of electromagnetic field present in a determined geographic position is important for dimensioning a new network and for upgrading and optimising the performance of an existing network.

Moreover, said techniques can have decisive importance to facilitate the action of locating the terminals of a mobile network, for instance in view of providing so-called Location Based Services (LBS), using locating techniques based on power measurements.

### BACKGROUND ART

A propagation model is a tool that enables to evaluate the level of the received signal (usually with reference to mean values) as a function of the radio-electric, geometric and environmental variables that characterise the mobile radio connection set up between transmitter and receiver.

Propagation models are very useful to all those who have to operate, for instance, a cellular network, because they are used when planning and simulating the physical layer of the mobile radio connection. Their use is also very useful for all those methods that aim to locate the mobile terminal through received power measurements.

In essential terms, two types of propagation models are present in the literature:
simple, i.e. elementary, propagation models, and
propagation models that use territorial databases.

A simple propagation model is a method that estimates the attenuation undergone by the electromagnetic signal according to elementary geometric parameters that characterise the mobile radio connection between transmitter and receiver (such as distance between the antennas, height of the antennas from the ground) and on the basis of the frequency of the transmission carrier. The propagation of the electromagnetic signal can be studied, for instance, according to the principles of geometric optics.

This category includes the Okumura/Hata model, known for instance from the volume T.S. Rapport, “Wireless Communications, Principles and Practice”, Prentice Hall PTR, 1996, pages 116-119.

Essentially, having as inputs the distance between the antennas of the transmitter and of the receiver, the carrier frequency and the heights of transmitter and receiver from the ground, such a model outputs the estimated attenuation.

Simple propagation models are essentially based on the observations conducted during tests for their calibration. These models have the drawback of not being very accurate in their estimation of the attenuation undergone by the signal during its propagation and of not being resistant against even small deviations from the test conditions.

The lack of accuracy can cause problems in the systems that use the model: for example, simulations may lose their closeness to reality because of errors in the field estimation, the precision of the locating engine can become poor, the dimensioning can be incorrect.

Models using territorial databases, instead, are more accurate and more refined: they aim to estimate magnetic field intensity in a point by exploiting the knowledge of cartographic data for the area where the signal is propagated. Their databases may contain information about the morphology of the territory or the presence of obstacles to propagation, such as buildings.

The latter category includes the solution described in US-B-6 021 316, which uses a two-dimensional map to determine the attenuation of a radio wave. The map contains geometric information on the buildings present in the are where the transmitter is located. The map is used to determine the paths through which the signal may propagate, both directly, and through reflections. The main disadvantages of the methods that use territorial databases are given by the difficulties connected to finding and maintaining the databases which must be kept up to date, as well as by the high computing powers required.

In particular, these methods are not suitable for use in:
systems for simulating mobile radio network which also use a simulation of the physical layer: using, in such a situation, refined methods for computing the electromagnetic field, simulation times may become too long and effectively not viable for current uses; and
systems for the broad planning and the initial dimensioning of mobile radio networks: in such a situation, the cost linked to the collection of the starting data necessary to constitute the databases does not appear justified by the application needs.

In the systems for estimating the position of mobile radio terminals by means of power measurements, to have very short computing times, simple propagation models must be available for use, also in view of the fact that maintaining and updating the cartographic data would have a negative impact on the costs of using and operating the system.

In this field of application, it is known that the geographic position where a terminal of a mobile communication network is currently located can be determined by measurements of the intensity of the electromagnetic field received by the terminal from the various radio base stations in the network.

In particular, locating techniques are known in which:
the mobile terminal measures the intensity of the electromagnetic field received from a certain number of radio base stations,
the measured values are compared with estimated values obtained by means of propagation models which lead to evaluate the possible values of the field produced by the radio base stations in the points of the territory covered by the network, and
the position of the mobile terminal is identified as the position where the difference between measured field values and the values projected by the propagation models is the smallest.

The necessary processing functions are usually carried out by a locating server connected to the network.

As demand for services linked to location grows, the need clearly emerges to enable the server to perform a very high number of locating operations, each of which must be completed in correspondingly short time and without employing very sizeable processing capacities. Hence the need to estimate the field value on the basis to models that are both simple and reliable.

This is particularly true if at least part of the locating function is to be performed by the mobile terminal itself, whose processing capacities are, as a whole, quite limited. This holds true even in the case of new generation mobile telephones, where the available application processor has good processing capacities compared with those available at this time in currently used cell phones.

The Applicant notes that, therefore, there are several possible usage contexts where:
on one hand, the methods based on simple propagation models are unusable, because of their inaccuracy, and
on the other hand, the more complex and sophisticated methods are also unusable for reasons of computational complexity and/or for the problems connected with the construction and maintenance of cartographic databases.

### DISCLOSURE OF THE PRESENT INVENTION

The Applicant tried to overcome the problems of possible inaccuracy of the methods based on simple propagation models, whilst retaining their virtues of implementation simplicity. At the same time, the Applicant sought solutions usable, for instance, in the systems for simulating mobile radio networks which also use a simulation of the physical layer, in the systems for estimating the position of mobile radio terminals through power measurements and in the systems for the preliminary planning and initial dimensioning of mobile radio networks, without giving rise to reasons for computational criticality and/or to problems connected with the construction and maintenance of cartographic databases.

The object of the present invention is to meet these needs.

According to the present invention, this problem is solved thanks to a method having the characteristics specifically set out in the appended claims. The invention further relates to a corresponding system, a communication network incorporating such a system and/or resulting from the application of the method according to the invention, as well as the related computer product able to be loaded in the memory of at least one electronic computer and comprising portions of software of code to implement the steps of the method of the invention:

in this context, said term shall be considered wholly equivalent to the mention of a computer-legible means comprising instruction for controlling a computer system to carry out a method according to the invention. The reference to “at least one electronic computer” is clearly meant to highlight the possibility of embodying the solution according to the invention with a decentralised architecture.

The invention solves the technical problem described above, providing for the evaluation of the signal level in a determined position (for instance, in a determined point of a mobile radio network) taking into account the topological characteristics of the network that serves the territory.

According to a preferred embodiment of the invention, therefore, an estimation is conducted of the field received from at least one source of electromagnetic field in a determined position of the territory covered by a communication network comprising a plurality of sources of electromagnetic field: the field is estimated on the basis of a propagation model, modifying the propagation model according to the topology of the sources of electromagnetic field.

The topological characteristics in question can be defined, for instance, starting from the geographic disposition of the Radio Base Stations. In particular, it is possible to introduce a parameter which depends on the topological characteristics of the network and to seek a dependence of the propagation model on this parameter.

The solution described herein yields more accurate results than those obtained with a simple propagation model, but is free of the disadvantages connected with the management of territorial databases, inherent in the more sophisticated models mentioned above.

In a preferred embodiment, the solution described herein aims to estimate the field not only on the basis of the geometric parameters of the link (for instance, mobile radio), as simple models already do, but also taking into account the topological characteristics of the network, in particular around the point where the receiver is located. In the case of a cellular mobile radio network, said topological characteristics of the network can be identified starting from the geographic disposition of the Radio Base Stations: this information is in any case available when the field within a cellular network is to be estimated.

The solution described herein is based on the observation of the fact that the dependence between signal level and topological characteristics of the network reflects the dependence between characteristics of the territory, in terms of building, morphology, presence of crops rather than woods, and the topological characteristics of the network. For example, in an urban environment, where a high concentration of buildings is present, the electromagnetic field encounters many obstacles to propagation and attenuates far more than in a rural environment. To assure an acceptable coverage level, a mobile radio network is usually designed to be denser in an urban environment, where signals attenuate more, than in a rural environment, where the signal transmitted by a cell can be distinguished even at high distances. Moreover, in an urban environment, cells are denser because a higher number of channels must be provided.

The solution described herein therefore has levels of accuracy that are comparable to those of the most sophisticated methods currently in use, without sharing with them the problem of implementation complexity and computational load. In particular, the experimental data obtained so far by the Applicants show a marked increase in accuracy with respect to traditional methods based on simple propagation models. All this whilst retaining the simplicity, reduced cost and rapid implementation of these known solutions.

### BRIEF DESCRIPTION OF THE ACCOMPANYING DRAWINGS

The invention shall now be described, purely by way of non limiting example, with reference to the accompanying drawings, in which:

FIG. 1 generally shows a possible context of employment of a system for estimating electromagnetic field intensity capable of operating according to the invention,

FIGS. 2 and 3 show the criteria for the possible selection of some parameters within the scope of the solution described herein, and

FIG. 4 is a flow chart illustrating an example of implementation of the solution described herein.

### DETAILED DESCRIPTION OF EMBODIMENTS OF THE INVENTION

The solution described herein is based on the idea of identifying a propagation model that depends on the topological characteristics of the mobile radio network in the point where the field is to be estimated.

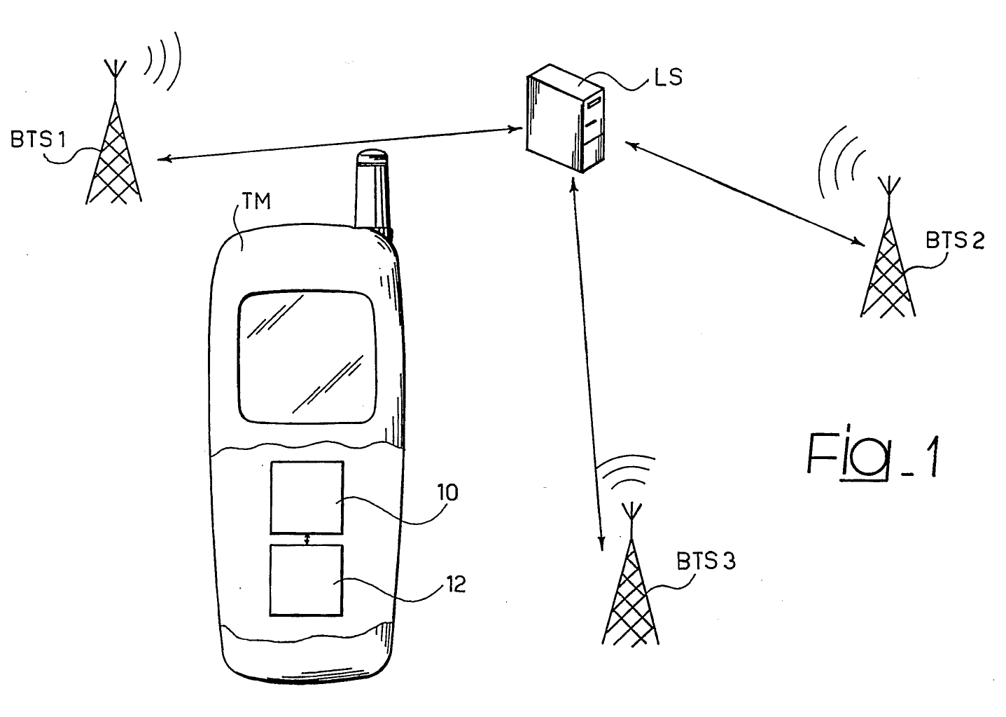

FIG. 1 shows a possible context of employment of the solution described herein, applied to locating a mobile terminal TM within a mobile radio communication system comprising a plurality of base stations BTS1, BTS2, BTS3, . . . .

The adoption of the acronym BTS (characteristic of GSM systems) must clearly not be construed to limit the scope of the invention: the communication system shown in FIG. 1 can correspond to any currently used standard.

In such a context, it is known that the geographic position where the mobile terminal TM is currently located can be determined from measurements of the intensity of the electromagnetic field received by the terminal TM from the various base stations BTS1, BTS2, BTS3, etc.

A locating technique of this kind exploits the ability of the mobile terminal TM to measure the intensity of the electromagnetic field received from the radio base stations BTS1, BTS2, BTS3 closest thereto.

The values thus obtained are compared to estimated values obtained by means of propagation models which lead to evaluate the possible value of the field produced by the radio base stations in the points of the territory covered by the network.

The position of the mobile terminal TM can thus be identified as the position where the difference between measured field values and the values projected by the propagation models is the smallest.

The required computing functions are usually performed by a locating server LS connected to the network, so that it is also able to exchange information with the mobile terminal TM (in particular to receive, for instance by means of SMS, the field values measured by the terminal TM).

Naturally, at least part of the locating function can also be performed by the same mobile terminal TM, which for this purpose exploits the processing unit 10 normally present in a mobile telephone (with a respective memory 12 associated thereto).

The criteria for implementing such a locating technique are deemed to be known in the art and therefore they shall not be illustrated in detail herein, also because they are not relevant, in themselves, for the purpose of understanding the invention.

Hereafter, the attention shall be particularly focused on the criteria with which the processing unit (server LS and/or mobile terminal TM) serving the function of estimating/evaluating the field values in the various points of the territory covered by the mobile communication network illustrated herein performs said estimation function on the basis of a model identified selectively and/or made available according to one or more parameters.

For this purpose, the dependence of the model from one parameter Δ associated to the topological characteristics of the network can be hypothesised. Obviously, this is not the only possible choice; multiple parameters could be considered.

If a single parameter is to be considered, a possible choice of Δ can correspond to a parameter representing cell density: for example it can be the number of cells per unit of surface in a given area of the territory covered by a cellular network. All this to apply to the field computation formulas such a weighting factor as to give rise to an attenuation whose value grows as cell density grows.

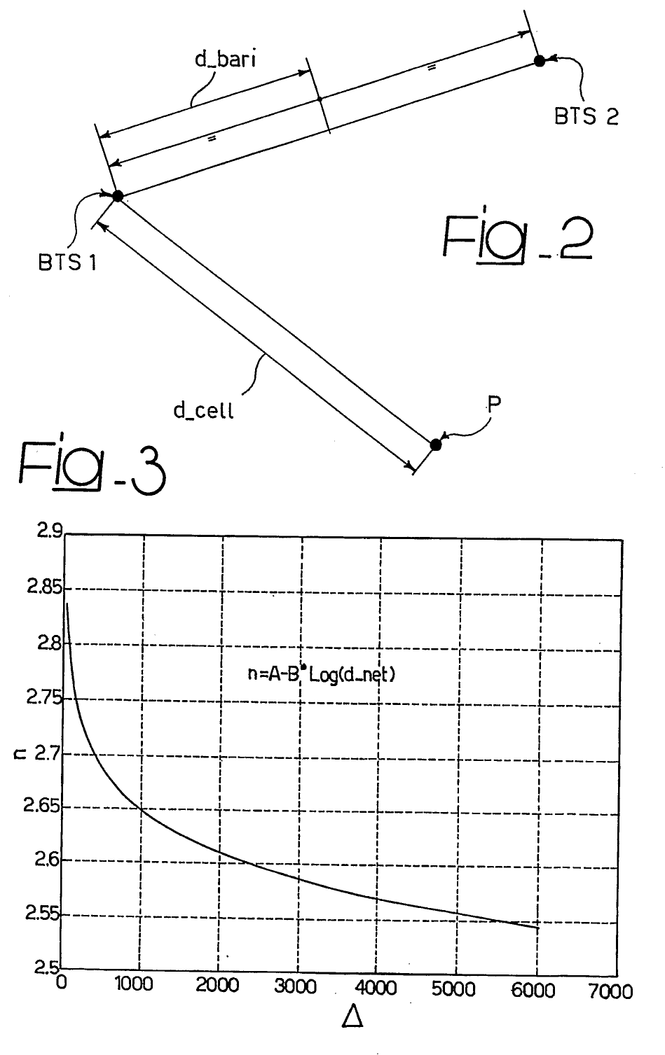

Another possibility, examined in greater depth herein and referred to the diagram of FIG. 2, is to attribute to each point P of the territory served by the mobile radio network a value of Δ determined in the following manner:
i) first of all, to each radio base station BTS1, BTS2, BTS3, . . . is associated a reference distance (d_bari) representing the distribution of the sources of electromagnetic field, i.e. of the radio base stations BTS1, BTS2, BTS3; the reference distance (d_bari) can be identified, for example, by the distance between the point where the radio base station in question is located and the centroid of the related cell-or-more simply, as half the distance (semi-distance) of the radio base station in question (BTS1, in FIG. 2) and the radio base station that is closest thereto (BTS2 in FIG. 2);
ii) then, to each point P is associated a distance, called distance from the cell (d_cell), calculated as the distance from the closest radio base station (which is presumed to be BTS1, in FIG. 2);
iii) to the point P is then associated a distanced called network distance (d_net), determined as follows:
   d_net=max(d_cell, 2·d_bari);

in practice, the cell closest to the point in question is identified and d net is taken to be the maximum value between its distance from the point and twice its d_bari; and
iv) the value of d_net thus calculated is then assigned to Δ.

As stated above, other choices are possible for the parameter Δ: the solution described herein is the choice currently considered preferential; said choice combines simplicity of implementation with the accuracy of the results achievable.

The dependence of the model on Δ can be modelled in several ways.

According to one way, the range of possible values of Δ is divided into N ranges. The selection of which and how many thresholds to introduce can be optimised. Subsequently, to each range can be associated a particular propagation model.

Another way to model the dependence of the model on Δ is to cause the model to vary in parametric fashion as the value of Δ changes. This is possible by making one or more parameters which appear in the model to depend for example in continuous fashion on Δ.

An example can be the following.

Let the attenuation undergone by the signal be according to the following form:

$${L}_{p} = 10 \cdot {log}_{10} [ {( \frac{4 π R}{λ} )}^{n} ]$$

where R is the distance between the antennas of the receiver and transmitter, λ is the carrier wavelength and n is the so-called path loss exponent.

Hence, it is possible to seek a function n=n (Δ), such that the path loss exponent (PLE) depends, for instance in continuous fashion, on Δ.

Experimental observations have shown that a plausible n=n (Δ) relationship is the one shown in FIG. 2 below, where Δ=d_net is in metres in the x-axis.

The law in question is a law of the type n=A−B. log Δ, where A and B are scaling constants which can be identified through a calibration action conducted “in the field”.

The path loss exponent (n, in the y-axis) is a measure of how quickly the signal attenuates as distance increases. The chart of FIG. 2 illustrates what has already been described: attenuation tends to decrease as Δ, i.e. as d_net, or cell size, increases.

Considering the example whereby Δ=d_net and n=n(Δ) is expressed by a relationship is expressed by a relationship of the kind shown in FIG. 2, the propagation model thus obtained has better performance than the Okumura-Hata model, without using cartographic data.

The Applicant has so far conducted tests relating to 32538 power measurements collected under multiple environmental situations, to constitute a good sample of the possible scenarios for the propagation of an electromagnetic signal.

In particular, statistical indices were obtained for the error with which the two compared models estimate received power.

It has been observed, through a direct comparison with the Okumura-Hata model, that the solution described herein has two essential advantages.

In the first place, its mean value is nil: the estimation of the field value is not polarised, whilst use of the Okumura-Hata model yields a mean value of almost 6 dB.

Additionally, error dispersion around the mean value is smaller. In particular, standard deviation, which is a measure of such dispersion, is 17% lower.

The improvements are still more evident if only the power measurements collected in extra-urban environment, numbering 9510, are considered. In this case, the mean value of the error for the solution described herein is still close to zero whilst improvement relative to Okumura-Hata is greater than 4 dB in terms of standard deviation.

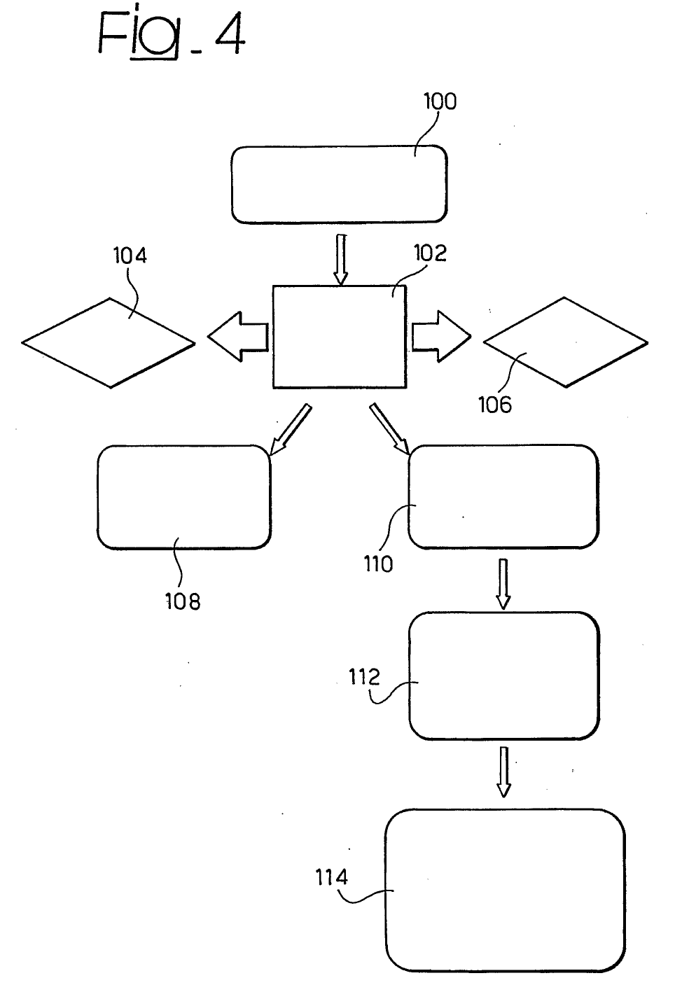

FIG. 4 shows a flowchart illustrating the solution described herein according to different possible embodiment. Each embodiment constitutes and example of implementation, capable of being achieved within a mobile terminal TM such as the one illustrated in FIG. 1.

In particular the step 100 indicates a step corresponding to the identification of a propagation model which depends on the topology of the network: it can be, for instance, the law which defines the attenuation Lₚ undergone by the signal as a function of the distance R between the antennas of the receiver and of the transmitter, of the carrier wavelength λ and of the path loss exponent n described above.

The step 102 corresponds to the identification of a criterion of dependence of the model on a parameter Δ which depends on network topology.

With reference to the above mentioned examples, Δ can be selected as a factor linked to cell density (step 104) or in the form of the parameter d_net mentioned several times above (step 106).

The blocks designated as 108 and 110 identify several procedures which may be adopted to express the variability of the model as a function of network topology.

For example, in the case of the step 108, the choice is to divide the range of variability of Δ into a plurality of intervals, each of which is associated to a respective model.

The step 110 instead identifies a solution, more extensively mentioned above, whereby a parameter of the propagation models continuously depends on Δ (see the diagram in FIG. 2). This specific choice is expressed by the steps 112 and 114, where the step 112 corresponds to the identification of the type of functional dependence of the parameter from Δ, whilst the reference 114 designates the step of scaling the constants on the basis of a calibration conducted on the field or by means of more detailed models.

Naturally, without altering the principle of the invention, the construction details and the embodiments may be widely varied relative to what is described and illustrated herein, without thereby departing from the scope of the invention, as defined by the appended claims.

1-24. (canceled)

25. A method for estimating the field received starting from at least one source of electromagnetic field in a determined position of the territory covered by a communication network comprising a plurality of sources of electromagnetic field, said method comprising the step of estimating said field on the basis of a propagation model and defining said propagation model according to the topologic characteristics of the sources of electromagnetic field of said plurality of sources of electromagnetic field in proximity to said determined position of the territory.

26. The method as claimed in claim 25, comprising the steps of:
identifying at least one parameter identifying said topologic characteristics, said parameter having a respective range of variability;
subdividing said range of variability of said parameter into a plurality of intervals; and
using, to estimate said electromagnetic field, a different propagation model for each of said ranges of said plurality.

27. The method as claimed in claim 25 comprising the steps of:
identifying at least one parameter identifying said topologic characteristics; and
estimating said electromagnetic field by using a single propagation model, said single propagation model being modified in parametric fashion as a function of the value of said parameter (Δ) identifying said topologic characteristics.

28. A method as claimed in claim 27, wherein said single propagation model is of the type
$${L}_{p} = 10 \cdot {log}_{10} [ {( \frac{4 π R}{λ} )}^{n} ]$$
where Lₚ is the attenuation coefficient, R is the distance between said determined position and said at least one source of electromagnetic field, and is the wavelength of said electromagnetic field and n is an exponent function of said parameter identifying the topologic characteristics of said network.

29. The method as claimed in claim 27, wherein said single propagation model is a function of an index (n) linked to said at least one parameter (Δ) by a relationship of the type
n=A−B·log(d_net),
where n is said index, d_net=Δ is said parameter identifying the topologic characteristics of said network, and A and B are scaling constants.

30. The method as claimed in claim 25, applied to a cellular communication network, comprising the step of modifying said propagation model according to a parameter identifying the density of the cells of said cellular network.

31. The method as claimed in claim 25, applied to a cellular communication network, comprising the step of modifying said propagation model according to a parameter identifying the distance of said determined position with respect to the source of electromagnetic field of said plurality of sources of electromagnetic field that is closest to said determined position.

32. The method as claimed in claim 31, comprising the steps of:
associating to each cell of said cellular network a reference distance representing the distribution of the sources of electromagnetic field of said plurality of sources of electromagnetic field;
associating to said determined position a cell distance identifying the distance between said determined position and the source of electromagnetic field of said plurality of sources of electromagnetic field that is closest to said determined position; and
identifying said parameter which identifies the topologic characteristics of said network as the greater value between said cell distance and a multiple of said reference distance.

33. A system for estimating the field received starting from at least one source of electromagnetic field in a determined position of the territory covered by a communication network comprising a plurality of sources of electromagnetic field, said system comprising at least one processing unit configured to estimate said field on the basis of a propagation model that is modifiable according to the topologic characteristics of the sources of electromagnetic field of said plurality of sources of electromagnetic field in proximity to said determined position of territory.

34. The system as claimed in claim 33, wherein said at least one processing unit is configured to:
identify at least one parameter (Δ) identifying said topologic characteristics, said parameter (Δ) having a respective range of variability;
subdivide said range of variability of said parameter (Δ) into a plurality of intervals; and
use a different propagation model for each of said intervals of said plurality to estimate said electromagnetic field.

35. The system as claimed in claim 33, wherein said at least one processing unit is configured to:
identify at least one parameter (Δ) identifying said topologic characteristics, and
estimate said electromagnetic field by using a single propagation model, said single propagation model being modified in parametric fashion according to the value of said parameter (Δ) identifying said topologic characteristics.

36. The system as claimed in claim 35, wherein said single propagation model is of the type
$${L}_{p} = 10 \cdot {log}_{10} [ {( \frac{4 π R}{λ} )}^{n} ]$$
where Lₚ is the attenuation coefficient, R is the distance between said determined position and said at least a source of electromagnetic field and is the wavelength of said electromagnetic field and n is an exponent function of said parameter (Δ) identifying the topologic characteristics of said network.

37. The system as claimed in claim 35, wherein said single propagation model is a function of an index (n) linked to said at least one parameter (Δ) by a relationship of the type
n=A−B. log(d_net),
where n is said index, d_net=Δ is said parameter identifying the topologic characteristics of said network, and A and B are scaling constants.

38. The system as claimed in claim 33, associated with a cellular communication network wherein said at least one processing unit is configured to modify said propagation model according to a parameter identifying the cell density of said cellular network.

39. The system as claimed in claim 33, associated with a cellular communication network wherein said at least one processing unit is configured to modify said propagation model according to a parameter (Δ) identifying the distance of said determined position from the source of electromagnetic field of said plurality of sources of electromagnetic field that is closest to said determined position.

40. The system as claimed in claim 39, wherein said at least one processing unit is configured to:
associate to each cell of said cellular network a reference distance representing the distribution of the sources of electromagnetic field of said plurality of sources of electromagnetic field,
associate to said determined position a cell distance identifying the distance between said determined position and the source of electromagnetic field of said plurality of sources of electromagnetic field that is closest to said determined position; and
identify said parameter (Δ) identifying the topologic characteristics of said network as the greater value between said cell distance and a multiple of said reference distance.

41. A communication network incorporating a system as claimed in claim 33.

42. A network as claimed in claim 41, wherein the network is for mobile communications.

43. A communication network resulting from the application of the method as claimed in claim 25.

44. A communication network terminal comprising a processing unit configured to implement the method as claimed in claim 25.

45. A method for simulating a mobile radio network able to use a simulation of the physical layer of the network, comprising a method for estimating the field as claimed in claim 25.

46. A method for planning a mobile radio network, comprising a method for estimating the field as claimed in claim 25.

47. A method for locating mobile terminals in a mobile radio network, comprising estimating the field as claimed in claim 25.

48. A computer program product able to be loaded into the memory of at least one electronic computer and comprising portions of software code capable of implementing the method as claimed in claim 25.
